(19) United States
(12) Patent Application Publication
(10) Pub. No.: US 2008/0118058 A1
(43) Pub. Date: May 22, 2008

(54) Splitter with Active Transient Suppression Circuit

(76) Inventor: Gyula Jakab, Nepean (CA)

Correspondence Address: WILLIAMS, MORGAN & AMERSON, 10333 RICHMOND, SUITE 1100, HOUSTON, TX, 77042, US

(21) Appl. No.: 11/562,440

(22) Filed: Nov. 22, 2006

(51) Int. Cl. H04M 1/00

(52) U.S. Cl. 379/442

(57) ABSTRACT

A splitter has input terminals for interfacing with a subscriber line and output terminals for interfacing with a telephonic device. The splitter includes a low pass filter and a transient suppression circuit. The low pass filter is coupled to the input terminals. The transient suppression circuit is coupled between the output terminals and the low pass filter and is operable to limit the rate of change of current through the splitter.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

The present invention relates generally to manufacturing and, more particularly, to telecommunications, and more particularly to a splitter with an active transient suppression circuit.

In communications systems, particularly telephony using the Publicly Switched Telephone Network (PSTN), it is common practice to transmit signals between a subscriber station and a central or remote switching office via a two-wire, bidirectional communication channel often referred to as the twisted pair or subscriber line. A line card generally connects the subscriber station to the central switching office. The functions of the line card include supplying talk battery, performing wake-up sequences of circuits to allow communications to take place, and the like. Voltage signals are processed and conditioned when being driven onto telecommunication lines.

The PSTN was designed primarily for voice communication, and thus provides an inadequate data transmission rate for many modern applications. To meet the demand for high-speed communication, designers have sought innovative and cost-effective solutions that would take advantage of the existing network infrastructure. Several technological solutions used in the telecommunications industry employ the existing network of telephone wires. A commonly used technology is the Digital Subscriber Line (xDSL or DSL) technology.

The use of xDSL improves the versatility of the existing network of telephone lines that was once considered virtually unusable for broadband communications. An ordinary twisted pair line equipped with DSL interfaces can transmit video, television, and high-speed data. The fact that more than six hundred million telephone lines exist around the world is a compelling reason for these lines to be used as primary transmission conduits for at least several more decades. Because DSL utilizes telephone wiring already installed in virtually every home and business in the world, it has been embraced by many as one of the more promising and viable options for broadband data communication.

There are now at least three popular versions of DSL technology, namely Asymmetrical Digital Subscriber Line (ADSL), Very High-Speed Digital Subscriber Line (VDSL), and Symmetric Digital Subscriber Line (SDSL). Although each technology is generally directed at different types of users, they all share certain characteristics. For example, all DSL systems utilize the existing, ubiquitous telephone wiring infrastructure, deliver greater bandwidth, and operate by employing special digital signal processing. Because the aforementioned technologies are well known in the art, they will not be described in detail herein.

DSL and PSTN technologies can co-exist in one line (e.g., also referred to as a “subscriber line”). Traditional analog voice band data interfaces (e.g., modems) use the same frequency band, 0-4 Kilohertz (KHz), as telephone service, thereby preventing concurrent voice and data use. A DSL interface, on the other hand, operates at frequencies above the voice channels, from 25 KHz to 30 Megahertz (MHz). Thus, a single DSL line is capable of offering simultaneous channels for voice and data. It should be noted that the standards for certain derivatives of ADSL are still in definition as of this writing, and therefore are subject to change.

DSL systems use digital signal processing (DSP) to increase throughput and signal quality through common copper telephone wire. DSL provides a downstream data transfer rate from the DSL Point-of-Presence (POP) to the subscriber location at speeds well over 1.5 megabits per second (MBPS).

Because subscriber lines used for DSL communication simultaneously carry both the voice and data signals in separate frequency bands, splitters are commonly used at the central office (CO) and customer premises equipment (CPE) to separate voice frequency signals from the higher frequency data signals. The splitter typically includes a low frequency portion for isolating the voice band signals and a high frequency portion for isolating the data band signals. The low frequency portion may be referred to as a plain old telephone system (POTS) splitter. Typical CPE POTS splitters employ a passive low pass filter (LPF) employing inductors, capacitors, and resistors (LCR) with filter orders ranging from 2 to 7.

The low pass filter is subjected to sharp voltage and current steps when the hook switch is closed or opened, during ringing of the telephone, and dial pulsing. In response to these step inputs, the LPF generates a high amplitude impulse response signal. This high level signal is mixed in with the data signal on the subscriber loop and causes data errors.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art. The present invention is directed to overcoming, or at least reducing the effects of, one or more of the problems set forth above.

### BRIEF SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

One aspect of the present invention is seen in a splitter having input terminals for interfacing with a subscriber line and output terminals for interfacing with a telephonic device. The splitter includes a low pass filter and a transient suppression circuit. The low pass filter is coupled to the input terminals. The transient suppression circuit is coupled between the output terminals and the low pass filter and is operable to limit the rate of change of current through the splitter.

Another aspect of the present invention is seen in a communication system including a subscriber line, a telephonic device, and a splitter. The splitter has input terminals coupled to the subscriber line and output terminals coupled to the telephonic device. The splitter includes a low pass filter coupled to the input terminals and a transient suppression circuit. The transient suppression circuit is coupled between the output terminals and the low pass filter and is operable to limit the rate of change of current through the splitter resulting from a status change associated with the telephonic device.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a simplified block diagram of a splitter interfacing with a telephony device in accordance with one illustrative embodiment of the present invention;

FIG. 2 is a circuit diagram of an active transient suppression circuit in the splitter of FIG. 1; and

FIGS. 3 and 4 illustrate current fall and rise time plots, respectively, for the splitter of FIG. 1 as controlled by the active transient suppression circuit of FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

One or more specific embodiments of the present invention will be described below. It is specifically intended that the present invention not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

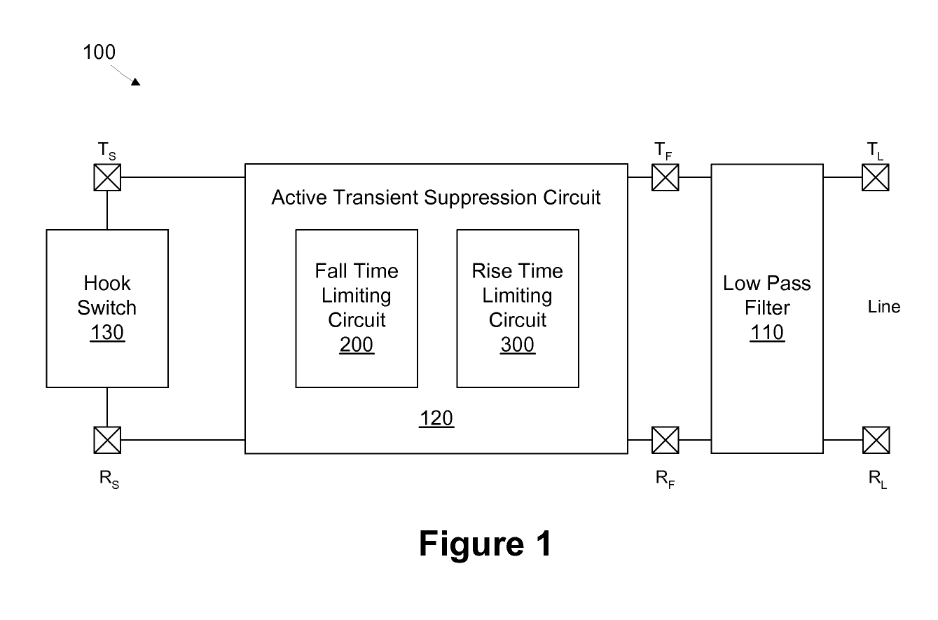

Referring now to the drawings wherein like reference numbers correspond to similar components throughout the several views and, specifically, referring to FIG. 1, the present invention shall be described in the context of an illustrative splitter 100. The splitter 100 may be employed in customer premise equipment (CPE) to isolate low frequency voice band signals from high frequency data band signals (e.g., DSL signals). Typically, the splitter 100 is connected to a telephone jack in the customer premise. A telephony device may be coupled to the splitter 100. Although not illustrated the splitter 100 may have a data jack to which a data device (e.g., DSL modem) may be connected and a voice jack to which a telephonic device may be connected. For ease of illustration and to avoid obscuring the present invention, only the voice band or low frequency portion of the splitter 100 is illustrated and described. The telephonic device may be a device capable of supporting pulse dialing and/or tone dialing. The term “telephonic device,” as utilized herein, includes a telephone, or any other device capable of providing a communication link between at least two users. In one embodiment, the telephonic device may be one of a variety of available conventional telephones, such as wired telephones, wireless phones, etc. In an alternative embodiment, the telephonic device may be any device capable of performing a substantially equivalent function of a conventional telephone, which may include, but is not limited to, transmitting and/or receiving voice and data signals.

As seen in FIG. 1, the splitter 100 includes a low pass filter 110 and an active transient suppression circuit 120. A telephonic device coupled to the splitter 100 is represented by a hook switch/dial pulsing contact 130. The output of the splitter 100 is represented by tip and ring terminals, T_{S} and R_{S}, respectively. Terminals, T_{L} and R_{L}, represent the line terminals of the subscriber line. Intermediate nodes, T_{F} and R_{F}, represent the output of the low pass filter 110. The active transient suppression circuit 120 includes a fall time limiting circuit 200 and a rise time limiting circuit 300. The low pass filter 110 provides isolation from the high frequency data signals present on the subscriber line. Various LCR circuits may be used to implement the low pass filter 110 as known to those of ordinary skill in the art.

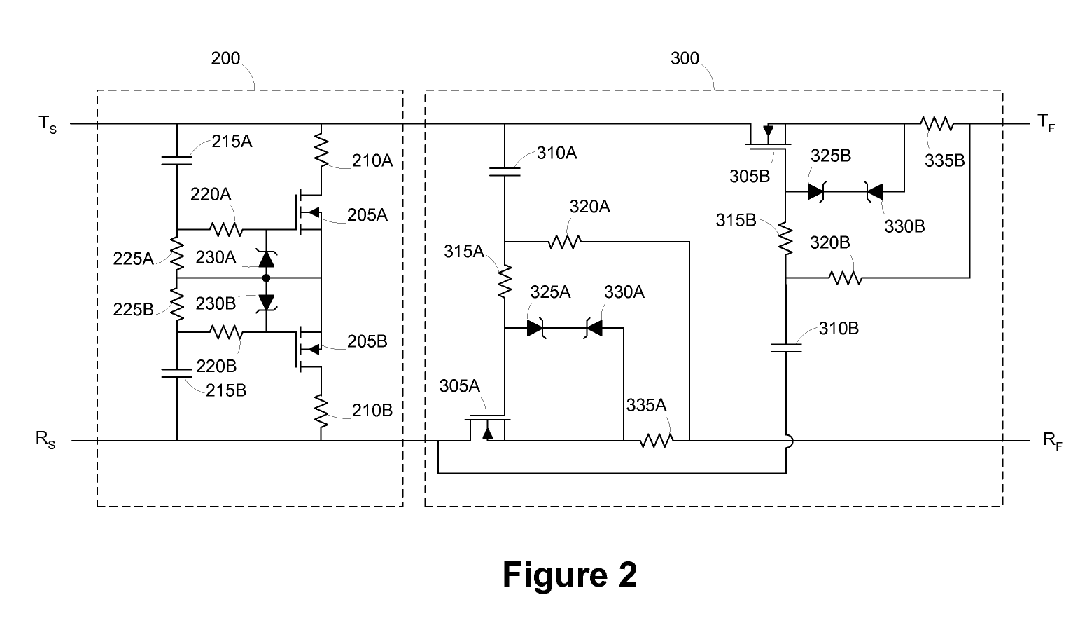

Turning now to FIG. 2, a circuit diagram of the active transient suppression circuit 120 is provided. The construct and operation of the fall time limiting circuit 200 is described first, followed by a description of the rise time limiting circuit 300. The components of the active transient suppression circuit 120 and some components of the low pass filter 110 (e.g., excluding the inductors) may be built using discrete components or may be integrated into a high voltage silicon chip.

The polarity of the signal across the T_{S} and R_{S} terminals may vary. Hence, the fall time limiting circuit 200 includes symmetric components for each polarity case to control the fall rate of current through the components of the splitter 100 when the hook switch/dial pulsing contact 130 transitions from a closed state to an open state (i.e., goes from off hook to on hook or dialing). By limiting the current fall time, the transients imposed on the subscriber line due to the impulse response of the low pass filter 110 are reduced. The symmetric components are differentiated the same reference numbers with “A” and “B” designators. The “A” components suppress transients if the voltage on the tip line is more positive than the ring line, while the “B” components suppress transients if the voltage on the ring line is more positive than the tip line. As the operation of the “A” and “B” components is identical due to the circuit symmetry, only the “A” components are described in detail.

The fall time limiting circuit 200 includes an enhancement mode MOSFET transistor 205A coupled through a resistor 210A to the T_{S} line. A capacitor 215A is also coupled to the T_{S} line. The gate of the transistor 205A is coupled through a resistor 220A to the capacitor 215A. A first end of a resistor 225A is also coupled to the capacitor 215A, and a zener diode 230A is coupled between the gate of the transistor 205A and a second end of the resistor 225A. The zener diode 230A acts as a protection diode to limit the voltage on the gate of the transistor 205A to approximately 10V. The resistor 220A limits current when zener diode 230A breaks down. The resistor 210A limits the instantaneous current through the transistor 205A.

When the hook switch/dial pulsing contact 130 is closed (i.e., the device is off hook), the capacitor 215A is in a discharged state and a steady state loop current (e.g., ˜40 ma) is present. The transistor 205A is in an off state. When the hook switch 130 opens, the loop current is interrupted causing a voltage transient to approximately 50V at the T_{S} and R_{S} terminals. The capacitor 215A is charged to approximately 50V. The charging of the capacitor 215A biases the transistor 205A to an on state allowing current to flow through the resistor 210A, the transistor 205A, and the transistor 205B. The transistor 205B is not active, but acts as a forward biased diode. The fall time of the current is controlled primarily by the relative sizes of the resistor 225A and the capacitor 215A. The resistance of the resistor 225A is large relative to that of the resistor 210B in the current discharge path, so the resistance of the resistor 210B has only a small effect on the time constant. When the capacitor 215A is fully charged, current ceases to flow through the resistor 220A and the gate-source voltage of the transistor 205A goes to zero turning it off.

The “B” components operate in a similar manner when the R_{S} line voltage is more positive than the T_{S} line voltage when the hook switch/dial pulsing contact 130 opens.

Turning now to the rise time limiting circuit 300, the transient introduced when the hook switch/dial pulsing contact 130 transitions from an open state to a closed state (i.e., goes from on hook to off hook) is reduced by limiting the current rise time. Again, symmetric components are differentiated the same reference numbers with “A” and “B” designators. The “A” components suppress transients if the voltage on the T_{S} line is more positive than the R_{S} line, while the “B” components suppress transients if the voltage on the R_{S} line is more positive than the T_{S} line.

The rise time limiting circuit 300 includes a depletion mode MOSFET transistor 305A in series with the R_{S} line. A capacitor 310A is coupled between the T_{S} line and the gate of the transistor 305A through a resistor 315A. A resistor 320A is coupled between the capacitor 310A and the R_{F} line. Zener protection diodes 325A, 330A are coupled between the gate and the source of the transistor 305A to limit the voltage applied to the gate of the transistor 305A. A resistor 335A is coupled in series between the source of the transistor 305A and the R_{F} line.

When the hook switch/dial pulsing contact 130 is open, the capacitor 310 is charged to a voltage equal to the difference between the T_{S} and R_{S} voltages. No current flows through the resistor 320A, so the voltage across the resistor 320A is zero, which puts the gate-source voltage of the transistor 305A also at zero volts. Because the transistor 305A is a depletion mode transistor, it is active (i.e., on) when the gate-source voltage is zero.

When the hook switch/dial pulsing contact 130 closes, the T_{S} and R_{S} voltage difference exhibits a step change. In response to the step change, the capacitor 310 begins to discharge, and the discharge current flows through the resistor 320A, developing a voltage across the resistor 320A which biases the gate-source voltage of the transistor 305A to a negative potential, thereby turning it off and limiting the current through the hook switch/dial pulsing contact 130. When the capacitor 310A is fully discharged, current through the resistor 320A ceases, and the gate-source of the transistor 305A drops back to zero, tuning the transistor 305A back on. The time constant of the rise time limiting function performed by the rise time limiting circuit 300 is determined by the values of the capacitor 310A and the resistor 320A. The resistor 335A provides a current limit function commonly employed with depletion mode transistors. When the voltage drop across the resistor 335A equals the threshold voltage of the transistor 305A, the transistor 305A turns off, thereby limiting the current to a value dependent on the resistance of the resistor 335A (i.e., I=V_{TH 305A}/R_{335A}).

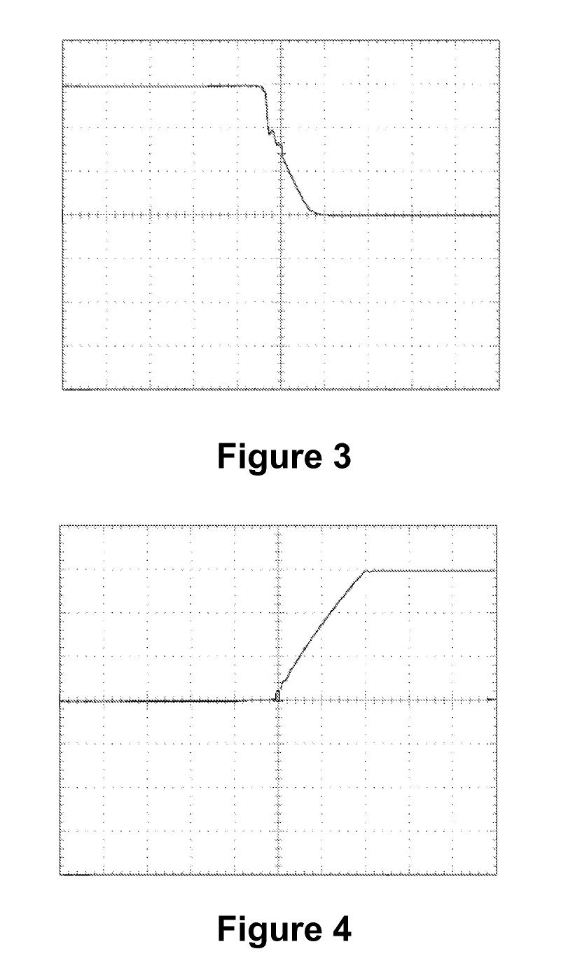

Referring to FIGS. 3 and 4, diagrams illustrating the current transitions during transitions in the state of the hook switch/dial pulsing contact 130 are provided. By limiting the current rise and fall times, as described above, the transients generated due to the impulse response of the low pass filter 110 are significantly reduced.

FIG. 3 shows the splitter current as controlled by the fall time limiting circuit 200. Rather than exhibiting a step change when the hook switch/dial pulsing contact 130 opens, the current response is closer to a ramp change. Similarly, FIG. 4 illustrates the splitter current as controlled by the rise time limiting circuit 300, which also approximates a ramp change. Reducing the spectral components of the current response reduces the high frequency interference signal generated by the splitter 100 that can cause data errors in the high frequency DSL data signal.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A splitter having input terminals for interfacing with a subscriber line and output terminals for interfacing with a telephonic device, comprising:
a low pass filter coupled to the input terminals; and
a transient suppression circuit coupled between the output terminals and the low pass filter and being operable to limit a rate of change of current through the splitter.

2. The splitter of claim 1, wherein the transient suppression circuit comprises a fall time limiting circuit.

3. The splitter of claim 2, wherein the fall time limiting circuit is coupled in parallel with the output terminals.

4. The splitter of claim 2, wherein the fall time limiting circuit comprises:
a first transistor having a first gate terminal and being coupled in parallel with the output terminals;
a first capacitor coupled in parallel with the output terminals and coupled to the gate terminal of the first transistor.

5. The splitter of claim 4, further comprising:
a second transistor having a second gate terminal and being coupled in series with the first transistor;
a second capacitor coupled in series with the first capacitor and coupled to the second gate terminal of the second transistor.

6. The splitter of claim 4, further comprising a first zener diode coupled between the first gate terminal and a first source terminal of the first transistor.

7. The splitter of claim 5, further comprising:
a first zener diode coupled between the first gate terminal and a first source terminal of the first transistor; and
a second zener diode coupled between the second gate terminal and a second source terminal of the second transistor.

8. The splitter of claim 4, further comprising a first resistor coupled in series with the first capacitor, wherein the first resistor is further coupled to a first source terminal of the first transistor, and the first gate terminal is coupled to a first node between the first capacitor and the first resistor.

9. The splitter of claim 5, further comprising:
a first resistor coupled in series with the first capacitor, wherein the first resistor is further coupled to a first source terminal of the first transistor, and the first gate terminal is coupled to a first node between the first capacitor and the first resistor; and
a second resistor coupled in series with the second capacitor, wherein the second resistor is further coupled to a second source terminal of the second transistor, and the second gate terminal is coupled to a second node between the second capacitor and the second resistor.

10. The splitter of claim 4, wherein the first transistor comprises an enhancement mode MOSFET transistor.

11. The splitter of claim 1, wherein the transient suppression circuit comprises a rise time limiting circuit.

12. The splitter of claim 11, wherein the rise time limiting circuit is coupled in series with at least one of the output terminals.

13. The splitter of claim 11, wherein the rise time limiting circuit comprises:
a first transistor having a first gate terminal and being coupled in series with a first one of the output terminals;
a first capacitor coupled between a second one of the output terminals and the first gate terminal.

14. The splitter of claim 13, further comprising a first resistor coupled between the first capacitor and the first gate terminal.

15. The splitter of claim 14, further comprising a second resistor coupled to a node between the first capacitor and the first resistor and a source terminal of the first transistor.

16. The splitter of claim 13, further comprising first and second zener diodes coupled in series and connecting a source terminal of the first transistor to the first gate terminal.

17. The splitter of claim 13, further comprising:
a second transistor having a second gate terminal and being coupled in series with the second one of the output terminals;
a second capacitor coupled between the first one of the output terminals and the second gate terminal.

18. The splitter of claim 17, further comprising a first resistor coupled between the second capacitor and the second gate terminal.

19. The splitter of claim 18, further comprising a second resistor coupled to a node between the second capacitor and the first resistor and a source terminal of the second transistor.

20. The splitter of claim 17, further comprising first and second zener diodes coupled in series and connecting a source terminal of the second transistor to the second gate terminal.

21. The splitter of claim 13, wherein the first transistor comprises a depletion mode MOSFET transistor.

22. A communication system, comprising:
a subscriber line;
a telephonic device; and
a splitter having input terminals coupled to the subscriber line and output terminals coupled to the telephonic device, the splitter comprising:
a low pass filter coupled to the input terminals; and
a transient suppression circuit coupled between the output terminals and the low pass filter and being operable to limit a rate of change of current through the splitter resulting from a status change associated with the telephonic device.

23. The system of claim 22, wherein the status change comprises at least one of the telephonic device going off hook, the telephonic device going on hook, the telephonic device ringing, and the telephonic device pulse dialing.
